(19) United States
(12) Patent Application Publication
(10) Pub. No.: US 2017/0231311 A1
(43) Pub. Date: Aug. 17, 2017

(54) Roobuck Cap Lamp Bracket

(71) Applicant: Roobuck Pty Ltd, Brookvale, New South Wales (AU)

(72) Inventors: Hanson Chen, Brookvale, New South Wales (AU); Henry Gong, Brookvale, New South Wales (AU)

(73) Assignee: Roobuck Pty Ltd, Brookvale, New South Wales (AU)

(21) Appl. No.: 15/503,176

(22) PCT Filed: Aug. 11, 2015
(86) PCT No.: PCT/AU2015/000476

§ 371 Date: Feb. 10, 2017

(30) Foreign Application Priority Data
Aug. 12, 2014 (AU) 2014903138
Mar. 17, 2015 (AU) 2015900951

(51) Int. Cl. A42B 3/04; F21V 21/14; F21V 17/10

(52) U.S. Cl. CPC A42B 3/0446; F21V 17/107; F21V 21/14

(57) ABSTRACT

An adaptor (1) for connecting a first object (2) to a second object (3). The adaptor having an elongate base (5) having a free end (5a) and a hinge end (5b), an elongate arm (10) having a free end (10a) and a hinge end (10b). The hinge end of said base hingedly connected to said hinge end of said arm so that said free end of said arm is moveable in use with respect to said free end of said base about a hinge defining a hinge axis (XX). The base having means (12) to connect said adaptor to said first object. The arm having means (14) to connect said adaptor to said second object. Whereby in use when said first and second objects are connected together a user can alter a position of said second object with respect to said first object without having to separate said objects.

### FIELD OF THE INVENTION

The present invention relates to a hinge adaptor and in particular an adaptor for use on helmets or the like. The present invention further relates to an adaptor for attaching a light to a mining helmet.

### BACKGROUND OF THE INVENTION

Adaptors are used throughout the world to connect items of various shapes and sizes. Adaptors having hinge mechanisms are also used throughout the world to provide the ability for two items to be connected together and moved relative to each other. Many adaptors and hinged adaptors are designed for specific purposes and not easily adaptable to many circumstances. Helmets or the like have been used for a long time to protect the heads of users in hazardous environments. As humans continue to conduct activities in inhospitable places and during hours when there is little light, assistance is required to provide safety. One such item used are lights or the like attached to helmets. Various other devices have also been attached to helmets to assist the user and to free the user's hands when controlling vehicles, tools or the like.

One problem with known attachments to helmets are that they tend to be fixed rigidly to the helmet and accordingly when a user moves their head, the attached item also moves in the same direction. This can be problematic in respect of attachments such as lights or the like which can shine into other person's eyes or be too bright on a work surface. That is, there is limited movement of the light with respect to the helmet.

One solution to this problem is a hinge clip by the current applicant. A hinge clip replaces the original clips on an item so that the item can turn more easily. However, the original clip has to be removed and replaced which can be difficult and problematic. It can also render the helmet not safe and defective not meeting regulated standards. Every item has its own design and many countries have their own standards to be met. Therefore, the hinge clip can only be designed for a certain item and not used for multiple items. For example it can be used with an Oldham cap lamp and cannot be used with any other cap lamps.

Different from a hinge clip, there is a need for a hinge adaptor which accepts items of all shapes and sizes and can be used in multiple countries. Therefore, the adaptor would have a much wider suitability than existing hinge clips.

Further, many helmets have different types of brackets for receipt of attachments and accordingly there is a need for a hinge adaptor that can be attached to many different types of helmets throughout the world and has flexibility to allow a range of movements.

There is also a need for a hinged adaptor which is relatively inexpensive to manufacture, easy to operate and easy to attach and remove from a helmet. There is a need for a secure attachment that will ensure the adaptor is not lost or accidentally removed.

### OBJECT OF THE INVENTION

It is an object of the present invention to substantially overcome or at least ameliorate one or more of the disadvantages of the prior art, or to at least provide a useful alternative.

### SUMMARY OF THE INVENTION

There is disclosed herein an adaptor for connecting a first object to a second object, said adaptor having:

an elongate base having a free end and a hinge end,

an elongate arm having a free end and a hinge end,

said hinge end of said base hingedly connected to said hinge end of said arm so that said free end of said arm is moveable in use with respect to said free end of said base about a hinge defining a hinge axis;

said base having means to connect said adaptor to said first object;

said arm having means to connect said adaptor to said second object;

whereby in use when said first and second objects are connected together a user can alter a position of said second object with respect to said first object without having to separate said objects.

Preferably, said first object is a helmet.

Preferably, said second object is a device to provide light.

Preferably, said connection means of said base includes an elongate member, said member being adapted for receipt with a bracket located on said helmet.

Preferably, said connection means of said base includes a raised portion, said portion being adapted for receipt with a bracket located on said helmet.

Preferably, said bracket includes a pair of opposing angle members defining a slot therebetween within which said connection means of said base can be located in use.

Preferably, said bracket includes a pair of legs separated by a bridging member, said legs and bridging member defining a slot therebetween within which said connection means of said base can be located in use.

Preferably, said base includes locking means to inhibit removal of said base from said bracket.

Preferably, said locking means includes a fastening means.

Preferably, said connection means of said base is a first planar member and said base further includes a second planar member substantially parallel to said first planar member and defining a slot therebetween within which the bridging member can be located in use.

Preferably, said fastening means is adapted to extend between said first and second members to inhibit removal of said base from said bracket.

Preferably, said arm includes mounting means adapted to permit mounting of said second object to said adaptor.

Preferably, said mounting means includes a pair of opposing angle flanges defining a slot therebetween adapted for receipt of said second object in use.

Preferably, said base includes a connection pad to be located in use between said base and said first object to assist with retaining said adapter to said first object.

### BRIEF DESCRIPTION OF DRAWINGS

A preferred embodiment of the invention will now be described, by way of example only, with reference to the accompanying drawings, wherein:

FIG. 1 is a first embodiment of an adaptor of the present invention;

FIG. 2 is a second embodiment of an adaptor of the present invention;

FIG. 3 shows the adaptor of FIG. 1 in a use position;

FIG. 4 shows the adaptor of FIG. 2 in a use position;

FIG. 5 shows a further embodiment of an adaptor of the present invention;

FIG. 6 shows a further embodiment of an adaptor of the present invention;

FIG. 7 shows the adaptor of FIG. 6 in a use position;

FIG. 8 is a third embodiment of an adaptor of the present invention;

FIG. 9 shows two adaptors of FIG. 8 being connected together to provide flexibility in light angle direction;

FIG. 10 is a fourth embodiment of an adaptor of the present invention;

FIG. 11 shows the flexibility of the adaptor of FIG. 10 in use;

FIG. 12 shows the adaptor of FIG. 11 folded; and

FIGS. 13a to 13e show photos of a sample of the above.

### DESCRIPTION OF EMBODIMENTS

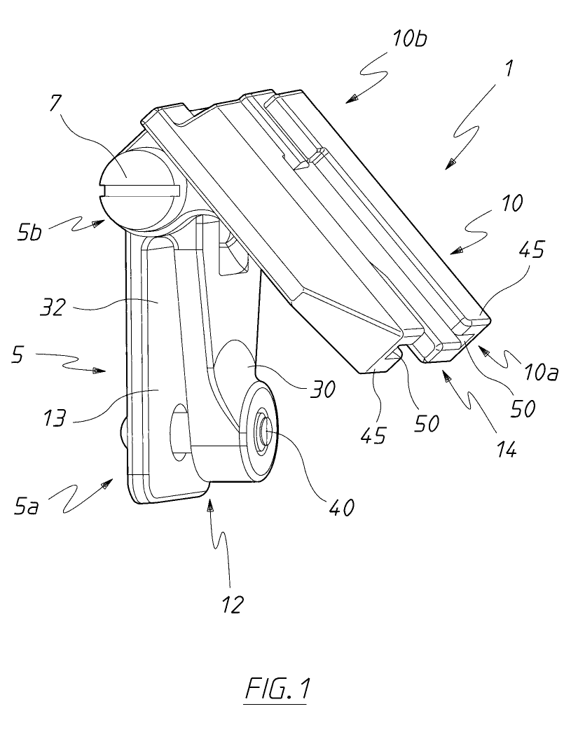

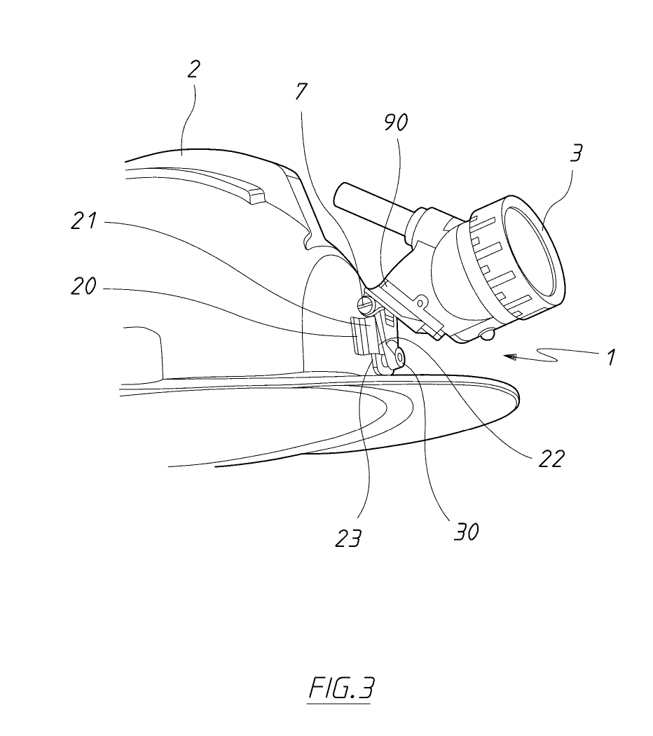

There is disclosed in the drawings an adaptor 1 for connecting a first object 2 to a second object 3. The objects 2, 3 could be any objects, however, in the preferred form the first object is a helmet 2 and the second object is a device to provide light such as a lamp, torch or the like 3. The adaptor 1 includes an elongate base 5 having a free end 5a and a hinge end 5b. The adaptor 1 also includes an elongate arm 10 having a free end 10a and a hinge end 10b. In the preferred form, the hinge end 5b of the base 5 is hingedly connected to the hinge end 10b of the arm 10 as best seen in FIG. 1 by a hinge 7 so that the free end 10a of the arm 10 is moveable in use with respect to the free end 5a of the base 5 about a hinge axis XX defined by the hinge 7. The preferred hinge 7 arrangement can best be seen in FIG. 7 showing a central shaft or pin 100 having a screwdriver slot 101 or the like at one end and being connected to one or more collars 102 extending from the base 5 and arm 10. The collars 102 being moveable about the shaft. The base 5 has means 12 to connect the adaptor 1 to the first object 2. The arm 10 also has means 14 to connect the adaptor 1 to the second object 3. In use, when the first and second objects 2, 3 are connected together a user can alter a position of the second object 3 with respect to the first object 2 or vice versa by using the hinge 7 without having to separate the objects 2, 3. That is, for example, if the second object 3 is a light (as shown in FIGS. 3, 4, 7), a user may not wish to have the light 3 shining in the eyes of someone they are talking to or may need to direct the light 3 to a different spot upon a wall, ceiling or away from a work surface. Accordingly, a user can easily manipulate the adaptor 1 to direct the light 3 in a different direction without having to separate the lamp 3 from the helmet 2 or adjust using a complicated mechanism.

In the embodiment of FIG. 1, the base 5 includes an elongate member 13 being the connection means. The elongate member 13 being adapted for receipt within a bracket 20 located on the helmet 2. The typical brackets 20 on these types of helmets 2 include two legs 21 and a bridging member 22 therebetween defining a hole or slot 23 where something can be received. In this form, the elongate member 13 can be inserted by a user in the slot 23 of the bracket 20 as best seen in FIG. 3. To provide further support, the base 5 can include a second planar member 30 substantially parallel to the elongate member (or first planar member 13) as best seen in FIGS. 1 and 3 defining a further slot 32 within which the bridging member 22 of the bracket 20 can be received. That is, the members 13, 30 will be on either side of the bridging portion 22 of the bracket 20. The base 5 can further include a locking means 40 to lock the members 13, 30 to the bracket 20 to inhibit removal of the adaptor 1 from the object 2. In the preferred form, the locking means 40 could be a screw, bolt and nut, press-stud or any other fastening means or the like.

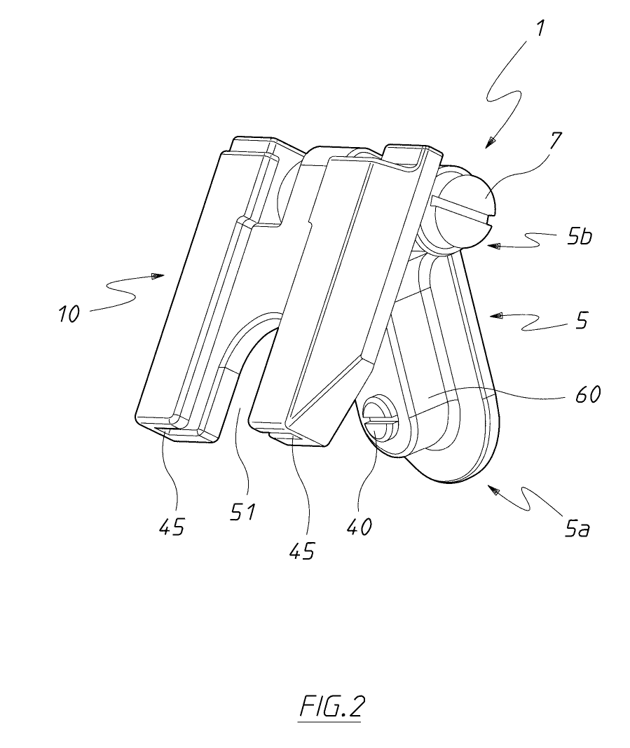

In the embodiment of FIGS. 2 and 4, the base 5 is of a different shape and includes a raised portion 60 extending along the base 5 from the hinge end 5b to the free end 5a which is adapted for receipt within a slot 70 on a slot style bracket 71 as best shown in FIG. 4. That is, in a slot style bracket 71 there are a pair of legs 72 and a bridging portion 73 but on one side of the bridging portion 73 a pair of opposing angled brackets 74 define the slot 70 to receive the raised portion 60 in one preferred form.

The locking means 40 in use passes through the bracket 71 to inhibit removal of the adaptor 1 from the helmet 2. In further embodiments discussed below, the locking means 40 (or screw) is not required.

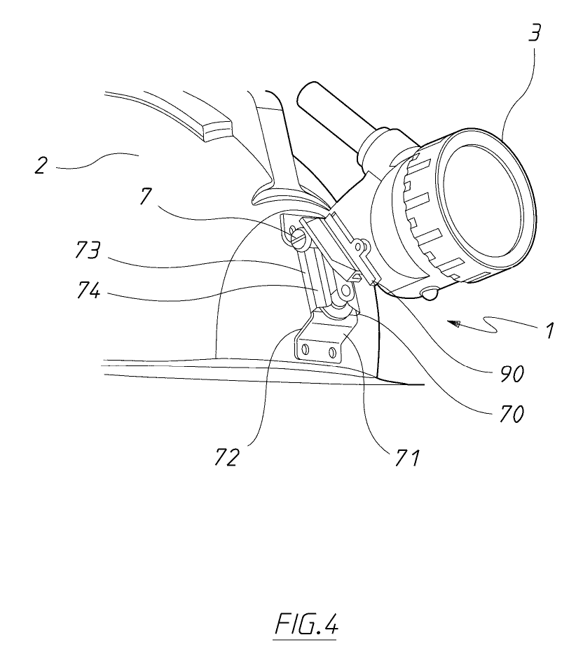

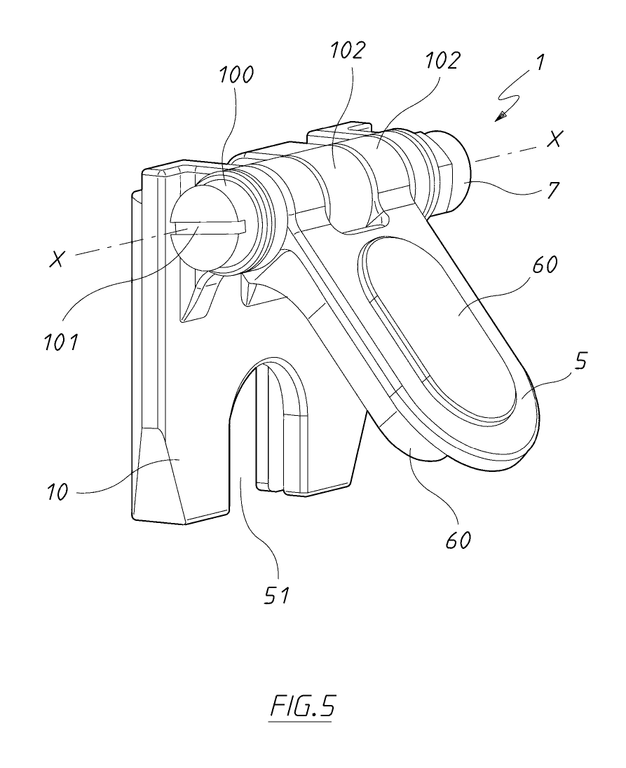

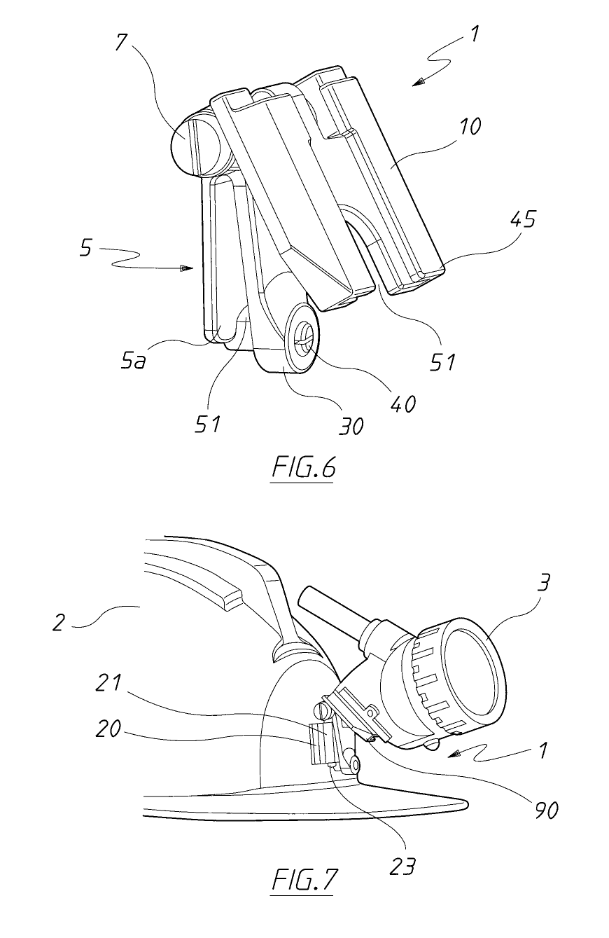

The arm 10 of the adaptor 1 as best seen in FIG. 1 also includes connection means 14 in the form of a pair of opposing angle brackets 45 which face each other and define a slot 50 for receipt of the second object 3. The arm 10 can include a cut-out 51 to assist with closing the adaptor 1 and for receipt of the raised portion 60. The base 5 could also include a cut out 51 as shown in FIG. 6. The base 5 could further include additional means to attach to the first object 2. For example, such as a rubber pad 60 which can also include an adhesive or the like as shown in FIG. 5. It will be appreciated that the light 3 can be slidably attached to the adaptor 1 via the slots 50, could be snap lockingly engaged, screwed or fastened or the like. Additional mounting means 90 could also be utilised to connect the object 2 to the adaptor 1.

Typically, miners helmets 2 for example have a bracket in the front and a clip on the back. To mount a cap lamp headpiece on to a helmet, you simply plug the headpiece clip into the helmet bracket. The light of the cap lamp 3 is a focused beam. The beam direction has about a 15 degree downward angle with a horizontal line. This angle is fixed because neither the bracket on the helmet 2 nor the clip on the headpiece has any mechanism to adjust this angle. The present invention in at least a preferred embodiment permits the cap lamp headpiece 3 to be moved up or down so the light beam direction can be changed easily. By adding two adapters together the degree of freedom of the angles becomes even greater as set out below.

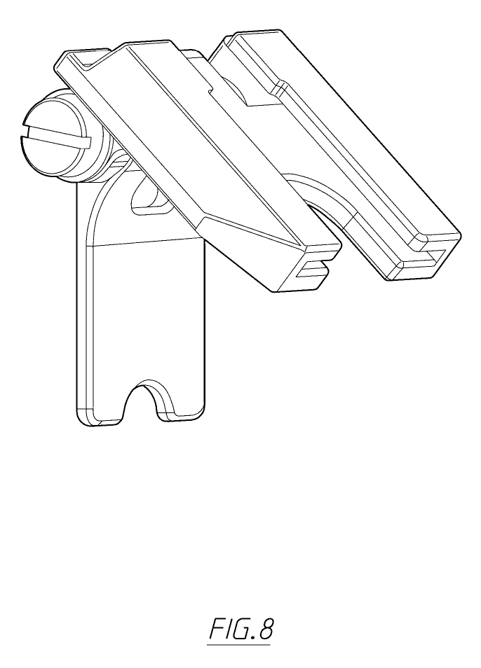

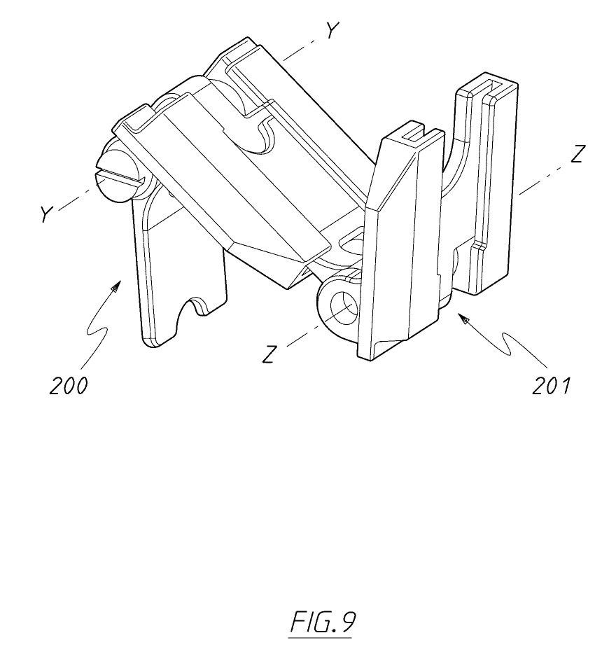

To further assist with the above, FIG. 8 shows a third embodiment of an adaptor 1, of the present invention. This embodiment is similar to FIGS. 1 and 2, except that there is no locking mean 40. This makes the adaptor 1 is suitable for all cap lamp brackets scarifying fastening capability of the adaptor to the bracket. One of the benefits of the adaptor of FIG. 8 is that two adaptors can be connected together as shown in FIG. 9 to achieve more flexibility in use. By connecting two adapters (200, 201) together, there are 2 axes Y, Z; a larger number of angles can be created allowing the light to be positioned in a larger variety of directions and positions, such as, for example, straight down at the ground or straight up at a mine roof

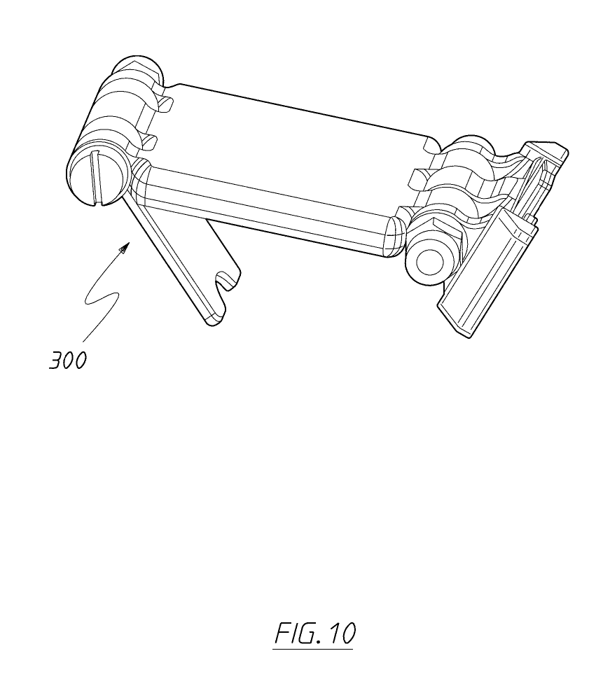

FIG. 10 shows a fourth embodiment of an adaptor 1 of the present invention. It is similar to the adaptor of FIG. 9 but is a single unit 300, rather than being two adaptors connected together.

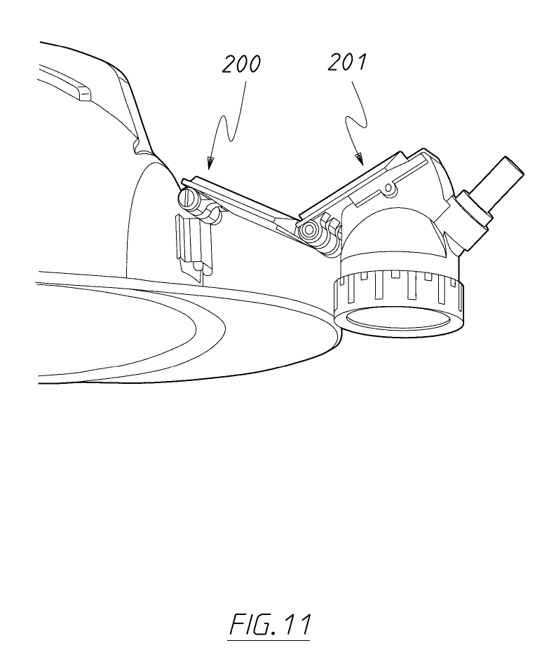

FIG. 11 shows that even a vertical light beam can be achieved with the third or fourth embodiments of the present invention.

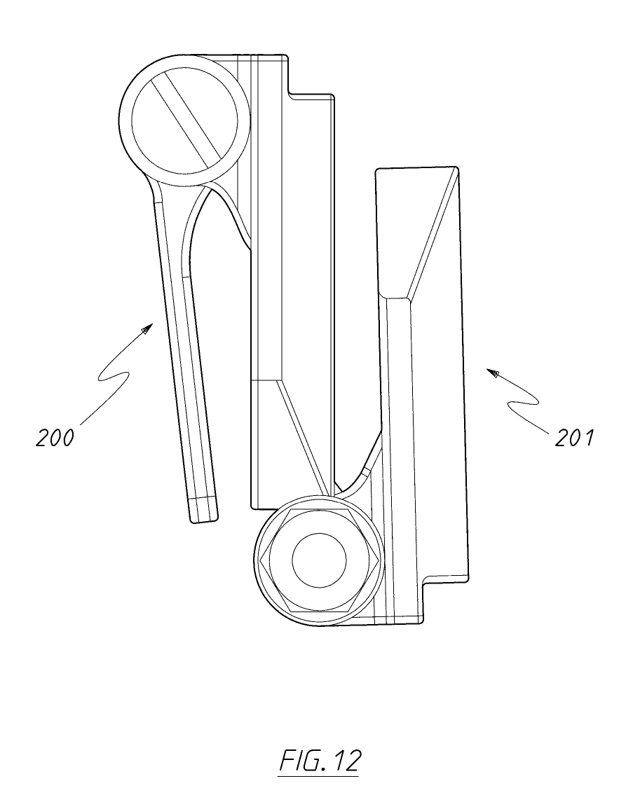

A downward light is significant for underground work such as mining. Miners need such a light beam occasionally. However, extreme angles make the helmet tilt forward so the miner may feel an imbalance of the helmet, although the cable holds the cap lamp and helmet up. Therefore, in a normal situation, the adaptor 1 folds up so it acts like a normal adaptor (like the first or second embodiment), as shown in FIG. 12. When a downward light is required, the adaptor can extend so the cap lamp can be adjusted for various angles, such as a vertical angle as shown in FIG. 11.

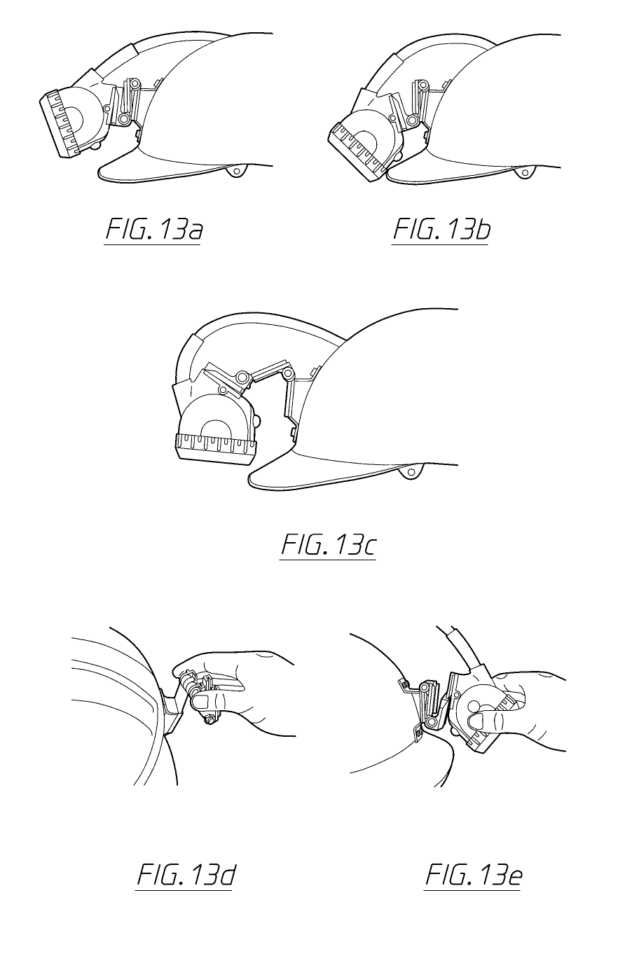

A series of photos showing a sample of the above is set out in FIGS. 13a to 13e.

Miners like to adjust beam angle in various situations. It is especially important to have a downward angle so the miner can comfortably read paper, check meters, and tighten a screw or the like.

Although the invention has been described with reference to specific examples, it will be appreciated by those skilled in the art that the invention may be embodied in many other forms.

1. An adaptor for connecting a first object to a second object, said adaptor having:
an elongate base having a free end and a hinge end,
an elongate arm having a free end and a hinge end,
said hinge end of said base hingedly connected to said hinge end of said arm so that said free end of said arm is moveable in use with respect to said free end of said base about a hinge defining a hinge axis;
said base having means to connect said adaptor to said first object;
said arm having means to connect said adaptor to said second object;
whereby in use when said first and second objects are connected together a user can alter a position of said second object with respect to said first object without having to separate said objects.

2. The adaptor according to claim 1, wherein said first object is a helmet.

3. The adaptor according to claim 1, wherein said second object is a device to provide light.

4. The adaptor according to claim 1, wherein said connection means of said base includes an elongate member, said member being adapted for receipt with a bracket located on said helmet.

5. The adaptor according to claim 1, wherein said connection means of said base includes a raised portion, said portion being adapted for receipt with a bracket located on said helmet.

6. The adaptor according to claim 1, wherein said bracket includes a pair of opposing angle members defining a slot therebetween within which said connection means of said base can be located in use.

7. The adaptor according to claim 1, wherein said bracket includes a pair of legs separated by a bridging member, said legs and bridging member defining a slot therebetween within which said connection means of said base can be located in use.

8. The adaptor according to claim 1, wherein said base includes locking means to inhibit removal of said base from said bracket.

9. The adaptor according to claim 8, wherein said locking means includes a fastening means.

10. The adaptor according to claim 9, wherein said connection means of said base is a first planar member and said base further includes a second planar member substantially parallel to said first planar member and defining a slot therebetween within which the bridging member can be located in use.

11. The adaptor according to claim 10, wherein said fastening means is adapted to extend between said first and second members to inhibit removal of said base from said bracket.

12. The adaptor according to claim 1, wherein said arm includes mounting means adapted to permit mounting of said second object to said adaptor.

13. The adaptor according to claim 12, wherein said mounting means includes a pair of opposing angle flanges defining a slot therebetween adapted for receipt of said second object in use.

14. The adaptor according to claim 1, wherein said base includes a connection pad to be located in use between said base and said first object to assist with retaining said adapter to said first object.
